(19) United States
(12) Patent Application Publication
(10) Pub. No.: US 2022/0180005 A1
(43) Pub. Date: Jun. 9, 2022

(54) SECURE SYSTEM-ON-A-CHIP (SOC) BOOTUP

(71) Applicant: Seagate Technology LLC, Fremont, CA (US)

(72) Inventors: Alphonsus John Kwok Kwong Heng, Singapore (SG); Lim Kian Beng, Singapore (SG); Saravanan Nagarajan, Singapore (SG)

(21) Appl. No.: 17/110,833

(22) Filed: Dec. 3, 2020

(51) Int. Cl. G06F 21/76; G06F 21/57; G06F 21/60; G06F 15/78

(52) U.S. Cl. CPC G06F 21/76; G06F 21/575; G06F 2221/0751; G06F 15/7807; G06F 21/602

(57) ABSTRACT

Systems, methods, and devices having systems-on-a-chip (SOCs) may utilize bootup code stored external from the SOCs. The bootup code may be verified by the SOCs. If the bootup code is not verified within a selected duration, the SOC may be reset or disabled. If the bootup code is verified within the selected duration, a reset circuit may be disabled.

The disclosure herein relates to secure bootup of a system-on-a-chip (SOC) using bootup code stored apart from the SOC (e.g., bootup code stored on a storage or memory device external to the SOC).

### SUMMARY

One illustrative system may include a storage device comprising bootup code and a system-on-a-chip (SOC) comprising a processor operably coupled to the storage device. The SOC may be configured to execute the bootup code from the storage device in response to power up of the SOC, verify the bootup code based on a signed portion of the bootup code, and reset or disable the SOC in response to failure of verification of the bootup code after a selected duration following power up of the SOC.

One illustrative method may include executing bootup code from a storage device external to a system-on-a-chip (SOC) in response to power up of the SOC, verifying the bootup code based on a signed portion of the bootup code, and resetting or disabling the SOC in response to failure of verification of the bootup code after a selected duration following power up of the SOC.

One illustrative data storage device may include a system-on-a-chip (SOC) that does not comprise read-only memory having bootup code and is operably coupled to an external storage device outside of the SOC. The external storage device may include bootup code and the SOC may be configured to execute the bootup code of the external storage device and reset or disable the SOC in response to failure of verification of the bootup code after a selected duration following power up of the SOC.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 is a schematic diagram of a prior art system-on-a-chip (SOC).

FIG. 2 is a schematic diagram of an illustrative SOC using bootup code stored apart from the SOC.

FIG. 3 is a flow diagram of an illustrative method of securely booting-up the SOC of FIG. 2 using bootup code stored apart from the SOC.

FIG. 4 is a schematic diagram of another illustrative SOC using bootup code stored apart from the SOC.

FIG. 5 is a schematic diagram of another illustrative SOC using bootup code stored apart from the SOC.

### DETAILED DESCRIPTION

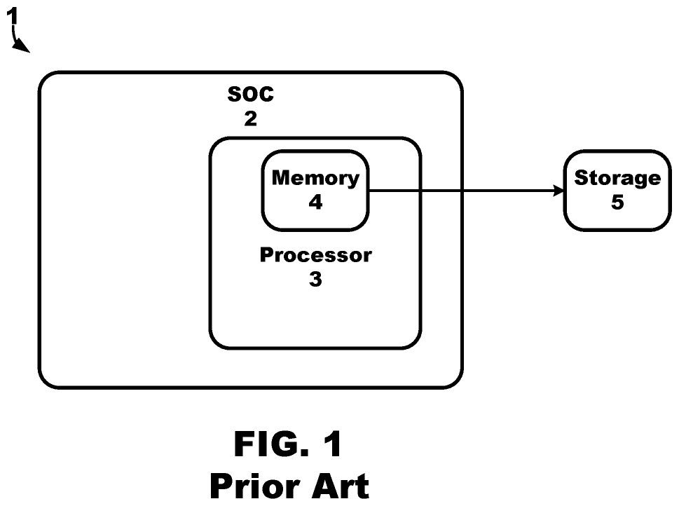

Illustrative systems, devices, and methods shall be described with reference to FIGS. 1-5. It will be apparent to one skilled in the art that elements or processes from one embodiment may be used in combination with elements or processes of the other embodiments, and that the possible embodiments of such systems, devices, and methods using combinations of features set forth herein is not limited to the specific embodiments shown in the figures and/or described herein. Further, it will be recognized that timing of the processes and the size and shape of various elements herein may be modified but still fall within the scope of the present disclosure, although certain timings, one or more shapes and/or sizes, or types of elements, may be advantageous over others.

The illustrative systems, methods, and devices may be described as providing read-only memory (ROM)-less secure system-on-a-chip (SOC) bootup. There is an increase in interest in securing SOC and the data and components thereof and related thereto. Further, use of SOCs of devices such, e.g., internet-of-things (IOT) devices, is increasing.

Typically, bootup code of a SOC 1 is stored in non-volatile, read-only memory (ROM) 4 on a processor 3 therein. When the SOC 1 is powered up, the bootup code located on or within the memory 4 is executed to bootup the SOC 1. After the SOC 1 is booted up, it can that access the external data storage 5.

When developing an SOC, the bootup code, which is typically stored in the ROM 4 on a SOC 1, may take a long time to develop, test, and tape-out (e.g., tape-out is the last step in development before manufacture). Further, when defects (e.g., bugs) exist in the bootup code that is already taped-out for the ROM, it could lead to one or both of useless bootup code and bootup code that can be exploitable (e.g., by hackers or malicious code). Further, such bootup that is already taped-out could be costly to fix or resolve since it would involve re-taping out wholly new bootup code or a new fix/work-around.

The present disclosure includes system, methods, and devices that resolve this issue in a secure manner by storing SOC bootup code on external storage that is verified before, immediately after, and/or during bootup. In other words, the bootup code may be removed from the SOC or microprocessor such that the bootup code is not part of the SOC or microprocess. Further, if the startup authentication or verification of such bootup code fails, the SOC or microprocessor may be disabled or reset (e.g., to stop or halt the execution thereof of unverified bootup code). Further, the present disclosure may be described as providing a means of securely booting up a SOC without having “built-in” bootup code, which removes the need to design and implement a bootup code in ROM on the SOC.

In at least one embodiment, an illustrative SOC boots up without the need of bootup code located on or within ROM of the SOC and runs initialization code in external storage that authenticates with the SOC. A delay circuit, which would reset or disable to the SOC, will be disabled after successful authentication. Conversely, the delay circuit will reset or disable to the SOC if it is not disabled after a selected or preset duration. For example, a delay circuit could be utilized that will disable the oscillator input to the SOC after the selected or preset duration from the SOC power up. In order to disable this delay circuit, the boot up code would have to successfully authenticate to the SOC by supplying the end address of the code to be verified, which would ensure data integrity and authenticity of the boot up code. Further, a set of security or authentication keys (e.g., cryptographic keys) could be stored in the SOC and used to verify the signature of the bootup code. Additionally, security or authentication key revocation may be employed for “roll-back” protection.

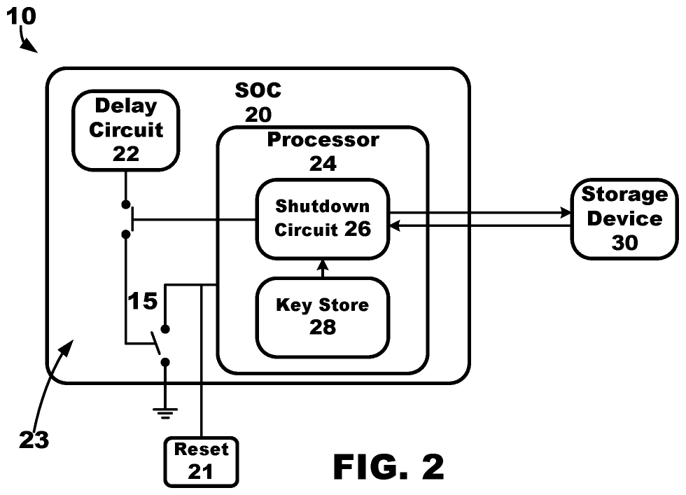

An illustrative system 10 is depicted in FIG. 2 that includes SOC 20 and external data storage device 30 operably coupled to the SOC 20 for data transfer therebetween. The SOC 20 includes, among other things, a processor, or processing device, 24, such as general-purpose processor or application specific integrated circuit (ASIC), configured to execute instructions to perform designated tasks.

The processor 24 is further configured to perform a boot sequence in response to receiving a reset indication via a reset signal to the reset pin 21. The reset indication can be generated in response to the SOC 20 being powered on, in response to actuation of a reset button or other input, or in response a reset circuit 23 triggering a reset in response to failure of verification of bootup code as will be described further herein.

The processor 24 includes a shutdown delay circuit 26 that may be described as a micro-code boot up authentication module that, once authenticated successfully, will disable the delay circuit 22. The authentication may employ asymmetric key or symmetric key algorithm. The micro-code of the shutdown delay circuit 26 may be described as including, at least, authentication code to shut down the delay circuit 22, verification code to perform signature checks of downstream code modules like boot firmware, disc operating firmware, firmware, etc. Additionally, in some embodiments, the shutdown delay circuit 26, processor 24, and/or SOC 20 may include a full cryptographic engine (e.g., a full cryptographic engine in application-specific integrated circuit (ASIC)) as will be described further herein.

The SOC 20, and in this embodiment, the processor 24 further includes a key store 28. The key store 28 may be used to store one or more cryptographic keys. The key store 28 may be used by the processor 24 to verify a signed portion of the bootup as will be described further herein. The key store 28 may be read-only and inaccessible by code stored externally from the SOC 20 to, e.g., provide security and tamper resistance. As described herein, symmetric or asymmetric key algorithms may be used for authenticating the bootup code.

Additionally, the key store 28 may include an indicator associated with each of the one or more cryptographic keys to activate or disable the associated key. More specifically, for example, the processor 24 or the key store itself 28 may one or more registers associated with or corresponding to each of the keys in the key store. The one or more registers may be used to disable or enable each of the keys. In this way, one or more key of the key store 28 may be revoked with modifying the read-only key store. In other words, the key store 28 may provide for key revocation. Further, the key store 28 may be write once (using, e.g., a one-time password). Still further, the keys of the key store 28 may have to be set in a secure manufacturing facility.

The reset circuit 23 may reset the SOC 20 in response to failure of verification of the bootup code. Generally, the reset circuit 23 is operably coupled to the processor 24 to disable the reset circuit 23 in response to verification of the bootup code. In this embodiment, the reset circuit 23 includes, among other things, a delay circuit 22 that is configured to wait (or count) a selected, or preset, duration from powerup of the SOC 20. Unless the delay circuit 22 is disabled by the shutdown circuit 26 (in response to bootup code being verified thereby), the delay circuit 22 will trigger the reset pin 21 thereby resetting or disabling the processor 24 and the SOC 20. In particular, in this example, the delay circuit 22 will operably couple via a switch 15 the reset pin 21 of the SOC 20 and processor 24 to ground, thereby resetting both, and the shutdown circuit 26 will operably disconnection the delay circuit from the switch 15 in response to verification of the bootup code.

In other words, the delay circuit 22 may be described as “holding down” the SOC reset pin 21 after a certain timeout (e.g., 15 seconds). The certain timeout would be selected to provide sufficient time for bootup code to authenticate to the SOC's 20 shutdown circuit 26. Additionally, if no security or authentication key is in key store 28, then the SOC 20 may default to disabling the shutdown circuit 26, delay circuit 22, etc. so as not disable the SOC 20 (e.g., will not shutdown SOC's 20 oscillator input).

The selected duration may between about 5 seconds and about 60 seconds. In at least one embodiment, the selected duration may be about 15 seconds. In other embodiments, the selected duration may be greater than or equal to 5 seconds, greater than or equal to 10 seconds, greater than or equal to 20 seconds, greater than or equal to 30 seconds, etc. and/or less than or equal to 60 seconds, less than or equal to 45 seconds, less than or equal to 25 seconds, less than or equal to 15 seconds, etc. As shown, the reset circuit 23 may include various circuitry selectively operably coupling the processor 24, the delay circuit 22, and the reset pin 21 to provide the functionality described herein. Although one such circuit configuration is depicted in FIG. 2, it is to be understood that present disclosure considers other circuit configurations that provide the same functionality.

The processor 24 of the SOC 20 may receive (e.g., read) the bootup code from external storage device 30. The storage device 30 may be any device or apparatus configured to store data (e.g., bits, binary data, etc.). The storage device 30 may include a storage medium that can include, but is not necessarily limited to, solid state memory, hard magnetic discs, floppy discs, magnetic tapes, optical discs, integrated circuits, volatile memory, nonvolatile memory, etc. Generally, the storage medium of the storage device 30 is nonvolatile memory, which can include any kind of computer memory that can retain information stored thereon when not powered. Examples of non-volatile memory that may be utilized as the non-volatile main memory include, but are not limited to, read only memory (ROM), flash memory, hard drives, and random-access memory (RAM).

Examples of ROM include, but are not limited to, programmable ROM (PROM) which can also be referred to as field programmable ROM; electrically erasable programmable ROM (EEPROM) which is also referred to as electrically alterable ROM (EAROM); and erasable programmable ROM (EPROM). Examples of RAM include, but are not limited to, ferroelectric RAM (FeRAM or FRAM); magnetoresistive RAM (MRAM); resistive RAM (RRAM); non-volatile static RAM (nvSRAM); battery backed static RAM (BBSRAM); phase change memory (PCM) which is also referred to as PRAM, PCRAM and C-RAM; programmable metallization cell (PMC) which is also referred to as conductive-bridging RAM or CBRAM; nano-RAM (NRAM), spin torque transfer RAM (STTRAM) which is also referred to as STRAM; and Silicon-Oxide-Nitride-Oxide-Silicon (SONOS), which is similar to flash RAM.

The storage device 30 may be described as being external because the storage device 30 is not part of or within the SOC 20. Instead, the storage device 30 is operably coupled to the SOC 20 for data transfer therebetween. As described herein, the storage device 30 may include, among other things, the bootup code for the SOC 20. In this way, the bootup code may be modified, revised, edited, etc. without substantial modification (e.g., re-taping out, etc.) the SOC 20. As described herein, since the bootup code may be modified, revised, edited, etc., the bootup code needs to be securely verified, which the present disclosure provides.

In other words, the external data storage device 30 will include the bootup code. Once the SOC 20 powers up, the boot up code, or at least a portion thereof, will have a limited time to be verified (e.g., verify the bootup code's authenticity) by the SOC 20. In at least one embodiment, the bootup code supplies the end address of a code segment to be verified. Further, in at least one embodiment, the bootup code will set a register in the SOC 20 to start the code verification.

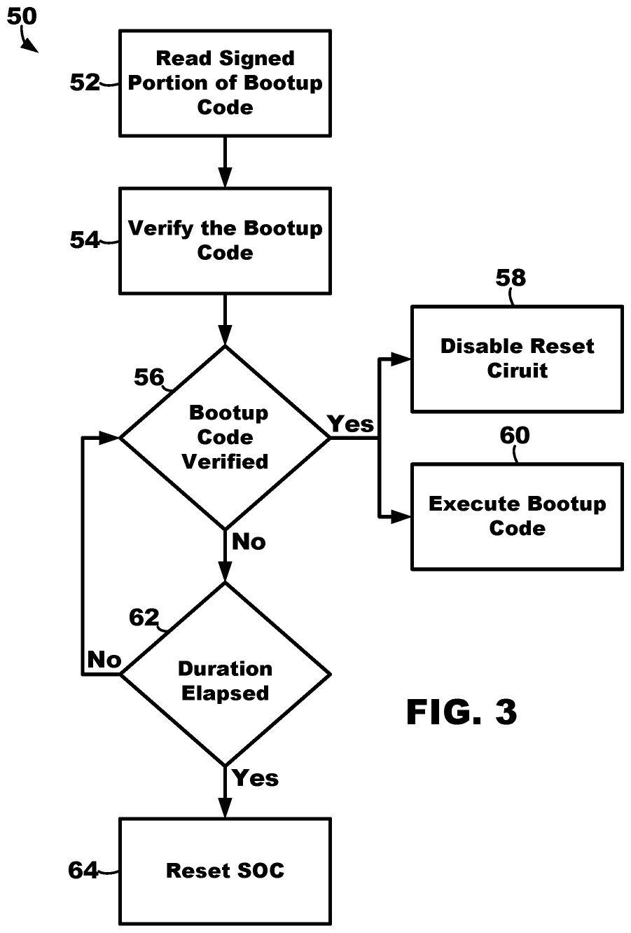

An illustrative method 50 of securely booting-up the SOC 20 of FIG. 2 using bootup code stored apart from the SOC 20 is depicted in FIG. 3. The method 50 include reading at least the signed portion of bootup code 52 from the external data storage. In at least one embodiment, the entire bootup code is read from the external data storage and then a signed portion of the bootup code is verified using the processor. In at least one embodiment, only the signed portion of the bootup code is read from the external data storage and verified using the processor prior to reading the remaining bootup code.

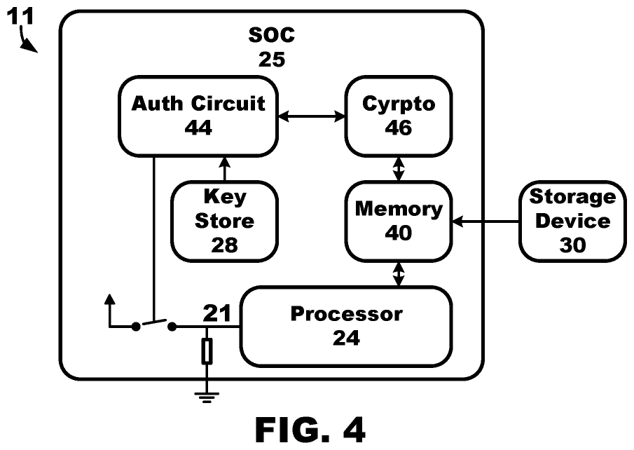

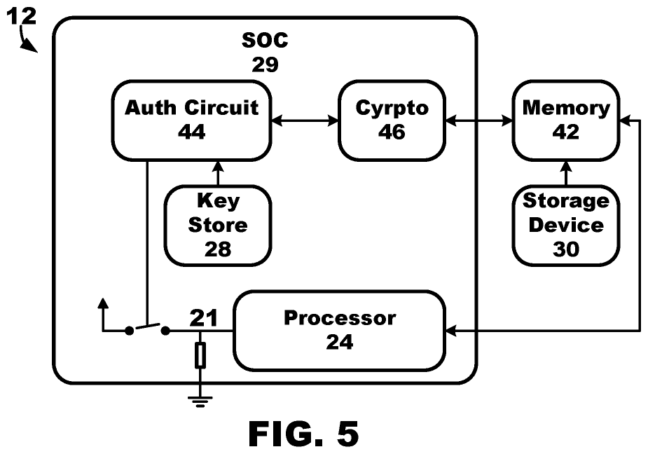

The method 50 may then include verifying the bootup code 54 based on, at least, the signed portion of the bootup code using the processor as shown in FIG. 2 or other cryptographic circuitry module as described with respect to FIGS. 4-5. Generally, the signed portion of the bootup code may be verified using one or more cryptographic keys of the key store. In one or more embodiments, the bootup code supplies an end address of the sign d portion (e.g., code segment) that is to be verified using the one or more cryptographic keys.

If the bootup code is verified 56, the method 50 may disable the reset circuit 58 and execute (or continuing executing) the bootup code 60. Additionally, it is understood that disabling the reset circuit 58, depending on the configuration, may, in turn, result in the execution of the bootup code since the SOC will not be reset or disable by the reset circuit. Further, if the bootup code is verified 56, the method 50 may determine whether the selected duration, or verification time period, has elapsed 62. If the selected duration has not elapsed, then the method 50 may continue waiting for verification of the bootup code 56. If the selected duration has elapsed, then the method 50 may reset the SOC 64, e.g., using the reset pin.

It is to be understood that the configuration of the SOC 20 depicted in FIG. 2 is only one example and that this disclosure contemplates various other configurations. For example, two different configurations are depicted in systems 11, 12 of FIGS. 4-5 that provide the same or similar functionality as described herein with respect to FIGS. 2-3.

The system 11 of FIG. 4 includes a SOC 25 substantially similar to the SOC 20 of system 10 of FIG. 2 except that includes an authentication circuit 44, cryptographic engine 46, and internal volatile memory 40 separate from the processor 24 to verify the signed portion using the key store 28. For example, the bootup code may be read from the storage device 30 into the internal volatile memory 40. The authentication circuit 44 may be operably coupled to the key store 28 and the cryptographic engine 46, which is operably coupled to the memory 40, such that the signed portion may be read from the internal memory 40 and verified, or conversely, not verified using the cryptographic engine 46. If the signed portion of the bootup code is not verified using the cryptographic engine 46, the authentication circuit 44 may reset or disable the processor 24 using the reset pin 21.

The system 12 of FIG. 5 includes a SOC 29 substantially similar to the SOC 25 of system 11 of FIG. 4 except that, instead of including internal volatile memory, the system 12 utilizes external memory 42 operably coupled to the storage device 30 to store the signed portion of the bootup code during verification. Thus, the signed portion of the bootup code may be read into external memory 42 from the storage device 30, and the cryptographic engine, which is operably coupled to the external memory 42, may verify, or authenticate, the signed portion. Upon verification of the signed portion, the cryptographic engine 46 may signal the authentication circuit 44 to disable or reset the processor 24 using the reset pin 21. The external memory 42 may be volatile memory but may be write protected to, e.g., protected the signed portion from being modified or manipulated. In one embodiment, a region of the external volatile memory 42 that is used for storing the bootup code may be protected from writing thereto.

In other words, the SOCs 25, 29 of FIGS. 4-5, upon power up, the SOCs 25, 29 will auto load the bootup code (or portions thereof) from the external data storage (e.g., flash storage) 30 on a data bus (e.g., a serial peripheral interface (SPI)) to the internal volatile memory 40 (e.g., static random-access memory (SRAM) or to the external volatile memory 42. The internal authentication circuit 44 will use the crypto engine 46 and a pre-shared key from or in the key store 28 to validate the authenticity of the bootup code in either the internal volatile memory 40 or external volatile memory 42. Upon successful authentication, the processor 24 will be reset and the processor 24 will execute the bootup code in the internal volatile memory 40 or external volatile memory 42.

If external volatile memory 42 is used, then the region in the volatile memory 42 that contains the bootup code will be set to “write protect.” In other words, if external volatile memory 42 is used, then for securing the authenticated code, the external volatile memory 42 used should have some feature to securely write protect a region.

Thus, the illustrative SOCs described herein may not include read-only memory having bootup code. Instead, the bootup code may be located externally to the SOCs, which may then be verified to disable a reset circuit.

The methods and/or techniques described in this disclosure, including those attributed to the SOC, processor, controller, or various constituent components, may be implemented, at least in part, in hardware, software, firmware, or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in programmers, such as physician or patient programmers, stimulators, image processing devices, or other devices. The term “controller,” “module,” “processor,” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, STRAM, RRAM, magnetic data storage media, optical data storage media, or the like. The instructions may be executed by one or more processors to support one or more aspects of the functionality described in this disclosure.

In the preceding description, reference is made to the accompanying set of drawings that form a part hereof and in which are shown by way of illustration several specific embodiments. It is to be understood that other embodiments are contemplated and may be made without departing from (e.g., still falling within) the scope or spirit of the present disclosure. The preceding detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g., 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

It is noted that terms such as “top”, “bottom”, “above, “below”, etc. may be used in this disclosure. These terms should not be construed as limiting the position or orientation of a structure, but should be used as providing spatial relationship between the structures.

Embodiments of the systems, apparatus, and methods for measuring latency in a storage device are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

What is claimed is:

1. A system comprising:
a storage device comprising bootup code; and
a system-on-a-chip (SOC) comprising a processor operably coupled to the storage device, wherein the SOC is configured to:
execute the bootup code from the storage device in response to power up of the SOC;
verify the bootup code based on a signed portion of the bootup code; and
reset or disable the SOC in response to failure of verification of the bootup code after a selected duration following power up of the SOC.

2. The system of claim 1, further comprising a reset circuit that resets the SOC in response to failure of verification of the bootup code.

3. The system of claim 2, wherein the processor is operably coupled to the reset circuit to disable the reset circuit in response to verification of the bootup code.

4. The system of claim 1, wherein the selection duration is less than or equal to 15 seconds.

5. The system of claim 1, wherein the SOC further comprises a key store, wherein verifying the bootup code based on the signed portion comprises verifying the signed portion using the key store.

6. The system of claim 5, wherein the key store is read-only and inaccessible by code stored externally from the SOC.

7. The system of claim 5, wherein the SOC further comprises an authentication circuit and cryptographic engine separate from the processor to verify the signed portion using the key store.

8. The system of claim 5, wherein the processor comprises the key store and verifies the signed portion using the key store.

9. The system of claim 1, wherein the SOC further comprises internal volatile memory, and wherein the signed portion of the bootup code is stored in the internal volatile memory.

10. The system of claim 1, wherein the system further comprises external volatile memory that is external to the SOC, and wherein the signed portion of the bootup code is stored in the external volatile memory, wherein a region of the external volatile memory storing the bootup code is protected from writing thereto.

11. A method comprising:
executing bootup code from a storage device external to a system-on-a-chip (SOC) in response to power up of the SOC;
verifying the bootup code based on a signed portion of the bootup code; and
resetting or disabling the SOC in response to failure of verification of the bootup code after a selected duration following power up of the SOC.

12. The method of claim 11, wherein a reset circuit resets the SOC in response to failure of verification of the bootup code.

13. The method of claim 11, wherein the selection duration is less than or equal to 15 seconds.

14. The method of claim 11, wherein the SOC further comprises a key store, wherein verifying the bootup code based on the signed portion comprises verifying the signed portion using the key store.

15. The method of claim 14, wherein the key store is read-only and inaccessible by code stored externally from the SOC.

16. The method of claim 14, wherein the SOC further comprises:
a processor; and
an authentication circuit and cryptographic engine separate from the processor to verify the signed portion using the key store.

17. The method of claim 16, wherein the processor comprises the key store and verifies the signed portion using the key store.

18. The method of claim 11, wherein the SOC further comprises internal volatile memory, and wherein the signed portion of the bootup code is stored in the internal volatile memory during verification.

19. The method of claim 11, wherein the signed portion of the bootup code is stored in external volatile memory that is external to the SOC during verification, wherein a region of the external volatile memory storing the bootup code is protected from writing thereto.

20. A data storage device comprising:
a system-on-a-chip (SOC) that does not comprise read-only memory having bootup code and is operably coupled to an external storage device outside of the SOC, wherein the external storage device comprises bootup code and the SOC is configured to execute the bootup code of the external storage device and reset or disable the SOC in response to failure of verification of the bootup code after a selected duration following power up of the SOC.
